(19) United States
(12) Patent Application Publication
(10) Pub. No.: US 2024/0030453 A1
(43) Pub. Date: Jan. 25, 2024

(54) BATTERY CELL RIVETING LAMINATE STRUCTURE

(71) Applicant: Our Next Energy, Inc., Novi, MI (US)

(72) Inventors: Qingcheng Zeng, San Jose, CA (US); Steven Kaye, Oakland, CA (US)

(73) Assignee: Our Next Energy, Inc., Novi, MI (US)

(21) Appl. No.: 18/224,759

(22) Filed: Jul. 21, 2023

Related U.S. Application Data
(60) Provisional application No. 63/391,551, filed on Jul. 22, 2022.

(51) Int. Cl. H01M 4/62; H01M 50/46; H01M 50/434; H01M 4/66

(52) U.S. Cl. CPC H01M 4/628; H01M 50/46; H01M 50/434; H01M 4/661; H01M 4/667

(57) ABSTRACT

An anode-free cell that includes a cathode and a separator-collector-separator structure. The separator-collector-separator structure includes a perforated anode current collector, and a polymer layer contiguously disposed on both surfaces of the perforated anode current collector through perforations in the perforated anode current collector. The polymer layer is a binder.

### FIELD

The disclosure relates generally to battery cell internal structures and more specifically, to a riveting laminate separator-foil-separator structure for cell design configured to provide a uniform pressure environment that may suppress lithium dendrite formation.

### BACKGROUND

Batteries usually have two electrodes comprising a cathode and an anode. The cathode may include a cathode current collector and a cathode active material, and the anode may include an anode active material and an anode current collector. Conventionally, the electrodes may be manufactured in a slurry casting method wherein, for example, a cathode electrode slurry mixture is coated onto a material, dried and compacted and the resulting electrode is cut and vacuum dried to produce a finished electrode.

In Lithium-ion cells, metallic microstructures, i.e., lithium dendrites, may form on the negative electrode during the charging process. Lithium dendrites may be formed when extra lithium ions accumulate on the anode surface and cannot be absorbed into the anode in time. They may cause short circuits and lead to catastrophic failures and even fires.

### BRIEF SUMMARY

The illustrative embodiments disclose a riveting separator-collector-separator design of anode-free cells. In one aspect, the anode-free cell may comprise a separator and an anode current collector configured as on unit. The unit, referred to herein as a separator-collector-separator structure may comprise a perforated anode current collector, and a polymer layer/binder contiguously disposed on both surfaces of the perforated anode current collector through perforations of the current collector. As used herein, the term contiguously disposed refers to a placing a polymer as a contiguous material running from one side of the current collector to the other, through the holes of the current collector. This may be achieved, for example, by coating the polymer/binder on the separator and laminating it on both sides of the current collector. The polymer may alternatively be coated directly on both sides of the current collector.

The separator-collector-separator structure may further comprise a base separator film separating the separator-collector-separator structure from an adjacent cathode and, a ceramic layer disposed between the base separator film and the polymer layer. The structure may provide the anode free cell with a compliant characteristic that imparts an inwardly directed pressure to confine lithium plating during a charge cycle of the anode-free cell.

In another aspect, a plurality of anode-free cells may be used to manufacture a battery pack. By employing the compliant characteristic of the anode-free cells, a use of external pressure provided to the cells via a mechanical configuration of the battery pack may be eliminated.

In yet another aspect, a method of manufacturing the anode free cell may be disclosed. The method may comprise manufacturing the anode free cell by providing a cathode and a cathode current collector, providing an anode current collector, creating a plurality of perforations in the anode current collector to form a perforated anode current collector, and contiguously disposing a polymer layer on the large surface areas of the perforated anode current collector through perforations in the perforated anode current collector. The method may further comprise forming the separator-collector-separator structure of the cell by placing the contiguously disposed polymer layer having the perforated anode current collector between both sides of a separator and gluing or adhering them together.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the cell and riveting laminate structure are set forth in the appended claims. The cell and riveting laminate structure itself, however, as well as a preferred mode of use, further non-limiting objectives and advantages thereof, will best be understood by reference to the following detailed description of the illustrative embodiments when read in conjunction with the accompanying drawings, wherein:

FIG. 1A depicts a cross-section of an anode-free cell in accordance with one or more embodiments;

FIG. 1B depicts a cross-section of a separator-collector-separator structure of an anode-free cell in accordance with one or more embodiments;

FIG. 1C depicts a cross-section of an anode-free cell after a charging operation in accordance with one or more embodiments;

FIG. 1D depicts a cross-section of a separator-collector-separator structure of an anode-free cell after a charging operation in accordance with one or more embodiments;

FIG. 1E depicts a cross-section of a separator-collector-separator structure of an anode-free cell in accordance with one or more embodiments;

FIG. 1F depicts a cross-section of a separator-collector-separator structure of an anode-free cell showing an inwardly directed pressure after a charging operation in accordance with one or more embodiments;

FIG. 2 depicts a block diagram of a power supply system in accordance with one or more embodiments;

FIG. 3 depicts a manufacturing process in accordance with one or more embodiments;

FIG. 4 depicts a block diagram of a computer system in accordance with one or more embodiments;

### DETAILED DESCRIPTION

The illustrative embodiments recognize that during the charging of a cell, lithium ions extracted from the cathode materials, may diffuse through the electrolyte-soaked separator, and then intercalate into graphite material. The interaction may be reversed during a discharge cycle. In these cells, the usable energy may be controlled by the type and amount of active materials present. An alternative to lithium-ion cells which holds more energy in the same volume are lithium metal batteries. Anode-free, anode-less or initial anode-free cells are a type of lithium metal cells. Lithium-metal cells may work in a similar fashion to lithium-ion cells but instead of using a graphite anode host material, may use a high-energy lithium metal. Anode-free lithium (Li) metal cells are lithium metal cells that may be manufactured without a lithium metal anode, or any other anode host material, such as graphite, titanate, iron-oxide, silicon, silicon-oxide. In some embodiments discussed herein, the anode-free cells may be cells wherein a lithium anode is subsequently generated, after manufacturing, in operando inside the cell during operation as the cell changes under an external influence when the cell is charged the first time. However, in other embodiments discussed herein, anode-free cells may be cells that have a ratio of anode capacity to cathode capacity being less than 1 when the cell in a fully charged state. In other words, all lithium may be removed from the cathode when the cell is fully charged. Lithium ions, provided by the cathode active material, may be deposited as metallic lithium onto a metal substrate, such as copper or nickel foil or mesh to create the working cell.

The illustrative embodiments recognize that conventional cells may have performance limitations along with safety issues due to the highly reactive nature of lithium metal, which can be incited in batteries through the formation of small structures called dendrites. When dendrites form, they may grow large enough to puncture cell layers, causing the battery to short-circuit and eventually catch fire. Thus, there may be significant obstacles in the commercialization of lithium metal and anode-free cells emanating from the growth of dendrites during repeated charge/discharge processes, and an associated low Coulombic efficiency (CE) of these processes. These barriers may consequently lead to a safety hazard due to the potential internal short circuits and the high surface area of the active material which result in high reactivity, as well as a short cycle life of such batteries emanating from the low CE of lithium cycling.

Given that lithium metal and anode-free cells may possess high capacities, said chemistries when managed properly, may achieve high practical/commercial cycle-life and/or energy density requirements and may be utilized to significantly extend the range of electric vehicles outside conventional capabilities, without the associated safety and CE barriers. The illustrative embodiments further recognize that conventional cell designs may not be able to provide the safety requirements via suppression of lithium dendrite growth unless, pressure, external to the cell, is applied on the cell to reduce the dendrite growth. Applying external pressure may however be costly and hinder the optimization of battery pack mechanical designs.

One or more embodiments may provide a riveting structure that utilizes an elastic polymer as a rivet to bond a separator-collector-separator structure together to form the anode electrode structure of an anode free cell an anode-free cell. The rivet bond may be configured to provide an internally produced, inwardly directed pressure which may suppress lithium dendrite growth.

For the clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of systems are used in the figures and the illustrative embodiments. In an actual battery pack or cell environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for power supply systems for electric vehicles and other similar systems using a variety of components that can be purposed or repurposed to provide a described operation, and such adaptations are contemplated within the scope of the illustrative embodiments.

The illustrative embodiments are described with respect to certain types of steps, applications, processors, and problems only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

In one or more embodiments, an anode-free cell may be disclosed. The anode-free cell may include a cathode current collector 106, a cathode 102, a separator 104, and an anode current collector 108, wherein the separator and the anode current collector may be configured as one unit in the form of a separator-collector-separator structure 110. “One unit” may refer to the structure being configured to have the polymer layer completely surround the current collector to form one entity that is assembled together as opposed to two different materials placed next to each other. In the anode-free cell, a metallic lithium layer 112 may be generated in operando during a first charging cycle of the cell. The layer of metallic lithium formed from lithium ions moving from the cathode 102 may be deposited on the anode current collector 108. The thicker the lithium layer 112, the higher the cell energy density. However, too thick of a layer a may lead to lower energy density than desired and an undesirable volume change during cycling, which can cause mechanical stresses that contribute to early cell failure. An optimum amount of Lithium may also have to be left to improve plating efficiency of the cell and meet practical energy density and cycle life requirements. The disclosed cell structure may not only expand to provide the inwardly directed pressure needed to form the form a dense layer of lithium while preventing or substantially preventing dendrite growth but may also contract during a discharge process of the cell to return to a previous shape.

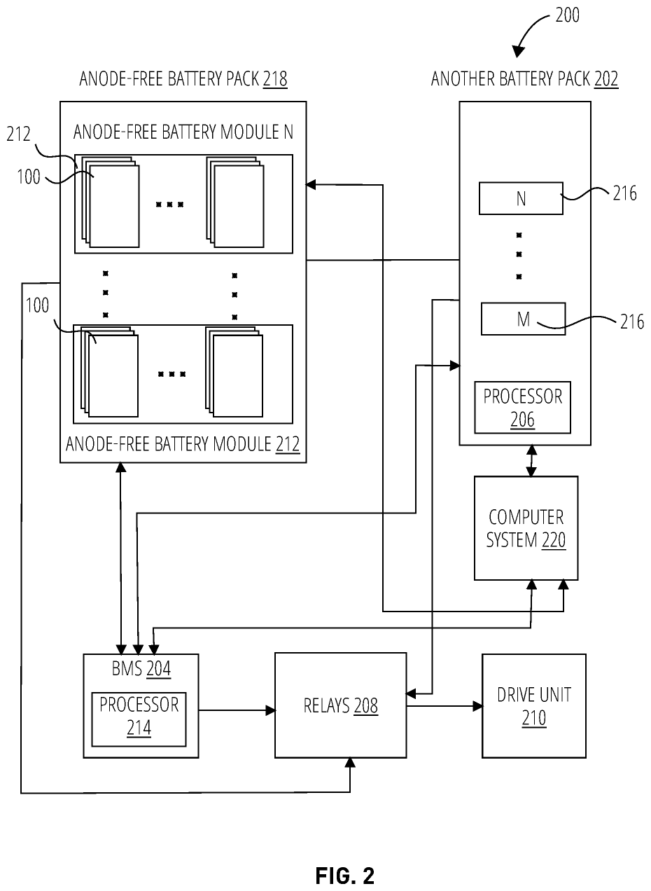

Before describing the cell in further detail, a power supply system in which the cell of the disclosure may be used is described. Embodiments described herein may be further directed to an anode-free battery module 212 in an anode-free battery pack 218 pack of a power supply system 200 which may be used for electric vehicles. The power supply system 200 (FIG. 2) may be configured to include anode-free cell chemistries in an architecture configured to enable the benefits of such chemistries, including significant increases in range, and significant increases in cycle life (provided, for example, by operating the cells under strict operating conditions/parameters) while protecting said architecture from the liabilities of said chemistries that have prevented them from otherwise being relied upon in the automotive field. The power supply system 200 may have another battery pack 202 (including, for example, lithium iron phosphate (LFP)) and an anode-free battery pack 218 comprising a one or more anode-free battery modules 212 that possess one or more anode-free cells 100 described herein.

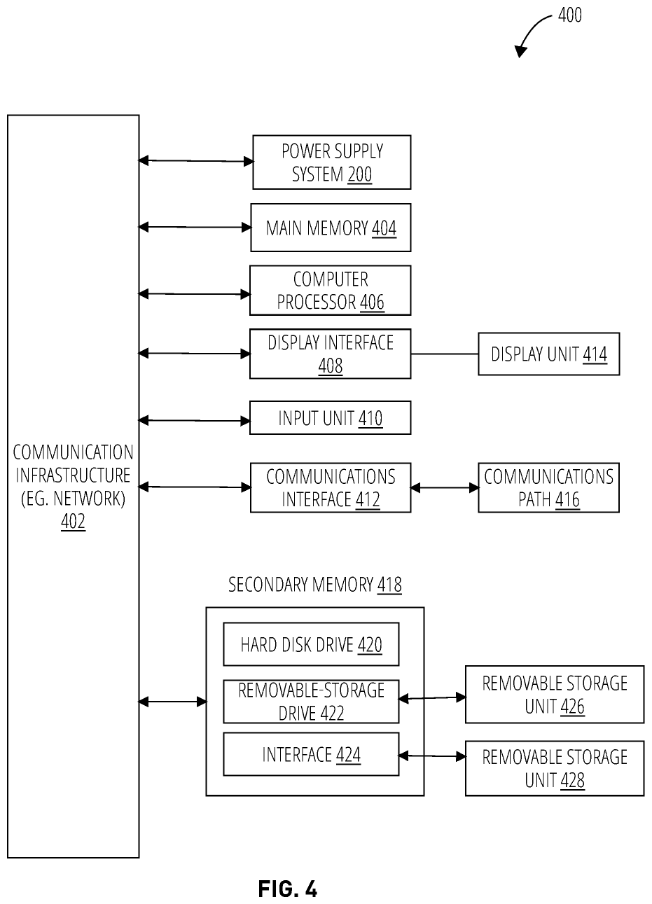

One or more embodiments includes one or more processors 206 (or processors 214, or computer processors 406, FIG. 4) included in or outside an on-board or external computer system 220 (or computer system 400, FIG. 4) to monitor and manage the electrical power discharging and charging processes of a battery and thus anode-free cells of the power supply system 200. The term electric vehicle or vehicle as used herein may collectively refer to electrified/electric vehicles, including, but not limited to, battery electric vehicles (BEV's), plug-in hybrid electric vehicles (PHEV), motor vehicles, railed vehicles, watercraft, and aircraft configured to utilize rechargeable electric batteries as their main source of energy to power their drive systems propulsion or that possess an all-electric drivetrain.

In one or more embodiments, the power supply system 200 may comprise said another battery pack 202 having one or more traction modules 216, an anode-free battery pack 218 comprising one or more anode-free battery modules 212, and a partition between said another battery pack 202 and the anode-free battery pack 218. However, this is only an example and is not meant to be limiting. Those having skill in the art appreciate that other types of battery devices and arrangement of anode-free cells 100 can be used to provide power in the embodiments described herein and, thus, the recitation of a certain configurations is not intended to be limiting. As discussed herein with reference to FIG. 2, a battery management system, BMS 204 is utilized by, for example, an on-board computer system 220 to control the electrical power discharge of said another battery pack 202 and/or anode-free battery pack 218 so that the power supply system 200 can be operated in a more efficient and power saving mode.

In an illustrative embodiment, the anode-free battery pack 218 has a plurality of anode-free battery modules 212 connected to each other and/or to said another battery pack 202. Battery systems in electric vehicles are typically traction batteries and are made up of hundreds of cells that are packed together. A battery management system (BMS 204) may be essential in the power supply system 200 for the safe operation of the high-voltage batteries. The BMS 204 may be configured to monitor the state of the batteries, prevent overcharging and discharging that may reduce the battery's life span, capacity and even cause explosions. For instance, a BMS may check the power voltage, and when the required voltage is reached, may stop the charging process. In case irregular patterns in the power flow are detected, BMSs may shut down and send out an alarm. Moreover, BMSs may be configured to relay the information about the battery's condition to energy and power management systems. In addition, they may regulate the temperatures of the battery cells, and also the battery's health, making it safe and reliable under all conditions. One of the desirable features of a BMS is to estimate the state-of-charge (SOC) of a battery pack as it desirable, or even critical to efficiently maintain the SOC of the battery packs to ensure that the voltage of the battery is not too high or too low. For example, the battery may not be charged beyond 100 percent or discharged below 30% percent SOC as this may reduce the capacity of the battery cells. Besides, a BMS may not only provide precise information on the voltage and temperature of the battery but may also give an idea of the energy available for use and the remaining battery charge.

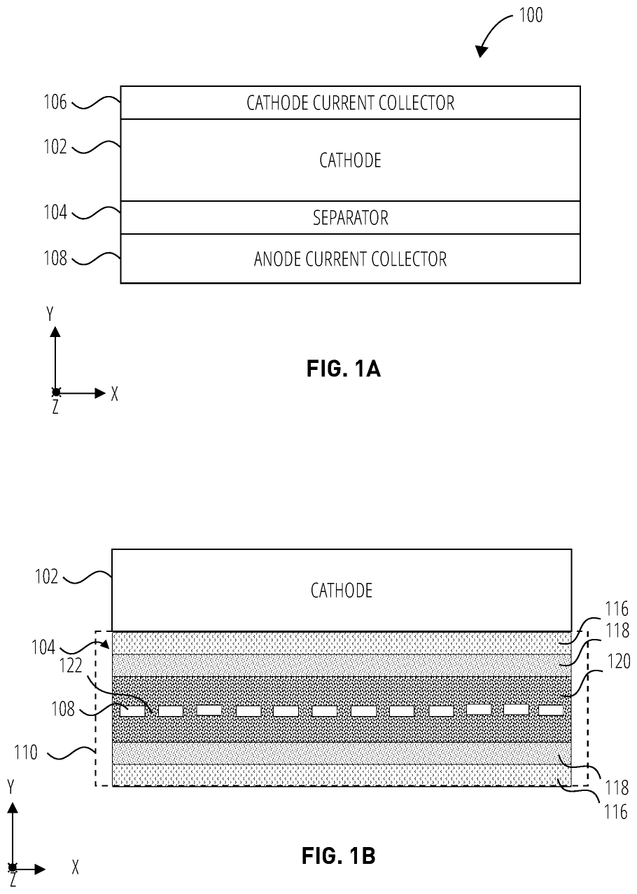

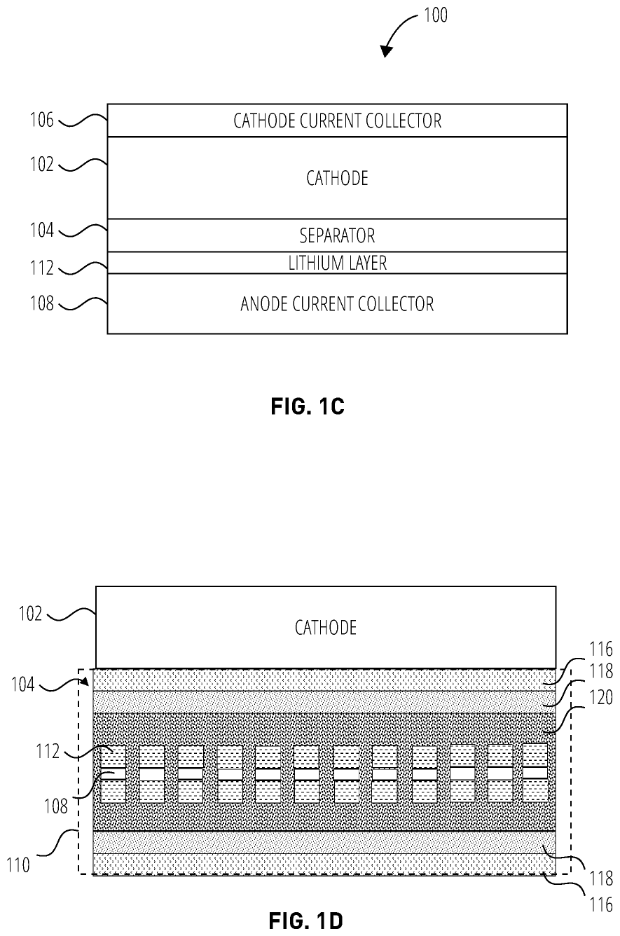

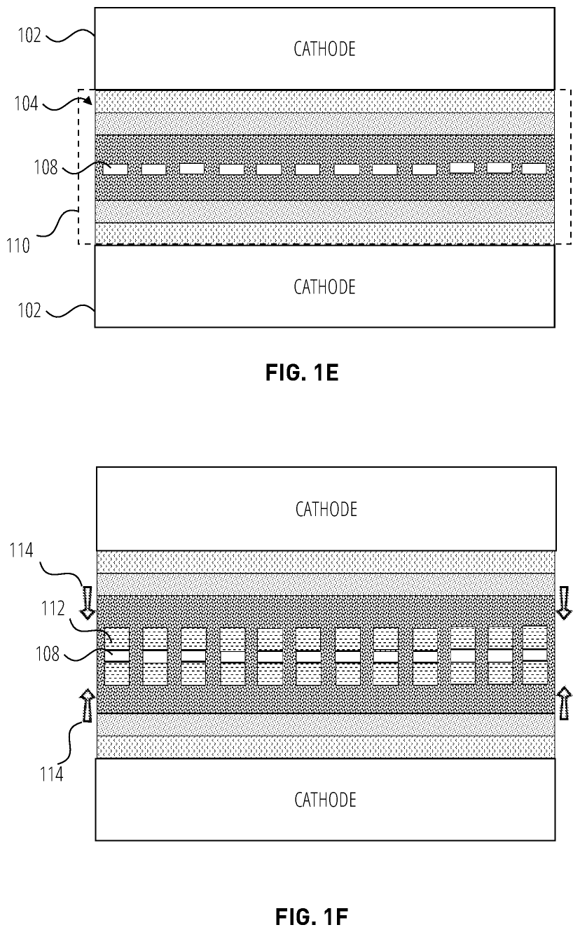

Turning back to FIG. 1A-FIG. 1F, an anode-free cell 100 is shown. The anode-free cell 100 may comprise a cathode current collector 106, a cathode 102, a separator 104, and an anode current collector 108, wherein the separator and the anode current collector may be configured as one unit in the form of a separator-collector-separator structure 110. The separator-collector-separator structure, as shown in FIG. 1B, may include a perforated anode current collector 108, and a polymer layer 120 contiguously disposed on longitudinal surfaces (in the X-Z plane) of the perforated anode current collector 108 through perforations 122 in the perforated anode current collector 108. The separator-collector-separator structure may thus be configured as one unit. Further, the polymer layer 120 may be a contiguous binder that is contiguous through said perforations 122. Thus, there may be two layers of the separator 104, and one layer of the perforated anode current collector 108 which may be laminated/sandwiched between the two layers or sides of the separator 104.

The cathode 102 may have a first surface in contact with the cathode current collector 106, an opposite surface of cathode 102 may be in contact with separator 104. The separator-collector-separator structure 110 may prevent a direct electrical connection between the cathode 102 and the anode current collector 108. In this configuration, as shown in FIG. 1A and FIG. 1B, prior to a first charging cycle, the anode-free cell 100 may not have an anode or lithium layer. After a first charging cycle, as shown in FIG. 1C and FIG. 1D, the anode-free cell may comprise an anode or lithium layer.

In an embodiment, the separator-collector-separator structure 110 further comprises a base separator film 116 separating the separator-collector-separator structure 110 from the cathode 102 and may also comprise a ceramic layer 118 disposed between the base separator film and the polymer layer 120.

The polymer layer 120 of the separator-collector-separator structure 110 may comprise a material that is compliant to applied forces by being expandable to accommodate lithium plating (FIG. 1D) while providing an inwardly directed pressure in the cell, based on its elastic characteristic, that constrains said lithium plating to a uniform space about the perforated anode current collector 108 and/or suppresses lithium dendrite formation as a result. The polymer layer being disposed contiguously on both sides of the anode current collector via the perforations 122, may provide a rivet-like bond for the separator-collector-separator structure 110.

In one aspect, the riveting provides several advantages including a uniform self-constrained space for lithium plating. If there is no constraining or pressure from both sides, when lithium plates on the anode current collector 108/foil, current density differences or reaction rate differences may be created, resulting in local dendrite growth that may break the separator.

More specifically, when performing lithium metal deposition, what may be needed is a smooth dense layer of lithium on the anode current collector. By exerting pressure on the cell, the lithium may be forced to deposit in a compact way to fix dendrite formation issues. Moreover, by originating the pressure internally via internal structure of the electrode stack (i.e., a binder/polymer layer 120 that rivets between the poles of the anode current collector and is glued/adhered/attached/affixed to both sides of the separator) benefits in the form of ease of use, cost savings, maintaining a simple pack mechanical design may be provided. This may be achieved through engineering of the microstructure of the cell components and application of the binder glue to hold the separator-collector-separator structure tightly. Thus, the binder may be configured with a compliant characteristic to both compress and expand as opposed to simply shifting.

In another aspect, the perforations of the anode current collector 108 may be distributed uniformly across the anode current collector 108. This may ensure that a uniform pressure is produced by the binder/polymer layer.

The perforated anode current collector 108 may comprise a material selected from the list consisting of: a Cu (copper) foil, a Ni (nickel) foil, a Ti (titanium) foil, a SS (stainless steel) foil, an Al (aluminum) foil, an alloy foil, and a metalized polymer film metallized with one or more of the foils. Moreover, any of the foils may be further plated with a different metal. Said different metal may have a thickness of 10 nm to 5 μm.

The metalized polymer film may comprise a material selected from the list consisting of PET (polyethylene terephthalate), PE (polyethylene), PP (polypropylene), PVC (polyvinyl chloride) and PI (polyimide). The foils of said metallized polymer film may also comprise one or more metal layers.

Even further, the perforated anode current collector 108 may have a pore size that ranges from 10 nm to 5 μm and a thickness of 3 μm to 50 μm. The polymer layer may also be of an elastomer. The polymer layer material may comprise PVDF (polyvinylidene fluoride), PTFE (Polytetrafluoroethylene) or PMMA (polymethyl methacrylate). Other technical features may be readily apparent to one skilled in the art from the following figures, and descriptions.

FIG. 1E and FIG. 1F show a cross section of the separator-collector-separator structure 110 between two cathodes before and after lithium plating respectively. As can be seen in FIG. 1F, an inwardly directed pressure 114 may be produced to provide even distribution of lithium plating and/or suppress lithium dendrite formation.

In an embodiment, a battery may be disclosed. The batter may comprise a plurality of anode-free cells 100 described herein. The plurality of anode-free cells 100 may be stacked together in a stacked configuration (e.g. Cathode-separator-perforated Cu foil-separator-cathode-separator-perforated Cu foil . . . ) wherein the anode-free cell may be assembled by cathode/separator-anode sub-units which may be stacked in the same direction, e.g., the Y-direction. Moreover, each anode-free cell 100 may have a winding configuration wherein the layers face each other and are wound to form a cylindrical cell.

The battery may also be operable by a battery management system to have one or more charge/discharge rates selected to optimize anode-free cell life. Other technical features may be readily apparent to one skilled in the art from the following figures, and descriptions.

Turing back to FIG. 2, the another battery pack 202 may include one or more traction modules 216 configured to power the vehicle. The anode-free battery pack 218 may be designed to be modular, having one or more than one type of chemistry, different form the chemistry of the another battery pack 202, for the purpose of providing the vehicle with its varying power requirements when needed. The chemistry may include at least an anode-free chemistry. Thus, the anode-free battery pack 218 may be designed to have one or a plurality of anode-free battery modules 212 or packs that are configured with respective bi-directional DC-DC converters to act as standalone batteries. By being able to independently control the anode-free battery modules 212, and independently measure the health or state of its individual anode-free cells 100, a charging and discharge rate the anode-free cells 100 may be regulated. In a non-limiting embodiment, anode-free cells 100 of the anode-free battery modules 212 are arranged in series. By using a balance device 324 such as a bleeder resistor connected in parallel with each anode-free cell 100, a rate of charging or discharging of the anode-free cell 100 can be controlled, i.e., turning on the bleeder resistor for a cell, discharges the electric charge stored in the cell. Further, one or more sensors (such as a voltage sensor) are used to measure a state of the individual anode-free cells 100 and/or the anode-free battery module 212.

In an embodiment, each anode-free battery module 212 may also have an operatively coupled controller to measure the health or state of the anode-free cells 100. For example, a controller may be configured to measure the voltage, current, temperature, SOC (State of Charge), SOH (State of Health) for all cells of the corresponding anode-free battery module 212. It may also have a DC-DC converter control to allow isolation and current to be managed and throttle their contribution, both absorbing and providing energy to a main bus/high voltage DC-DC bus of the power supply system 200. The system may also have the BMS 204 configured to communicate with the another battery pack 202. In case said another battery pack 202 malfunctions, one of more of the anode-free battery module 212 may act as a replacement, (e.g., temporary replacement) for the another battery pack 202 by supplying power directly to the drive unit 210. One or more processors (processor 214, processor 206 or a processor of computer system 220) may be used in a number of configurations to enable the performance of one or more processes or operations described herein. Relays 208 may be controlled to operatively couple a drive unit 210 of the vehicle to power from the power supply system 200. The drive unit 210 may collectively refer to devices outside the power supply system 200 such as a propulsion motors, inverter, HVAC (Heating, Ventilation, and Air Conditioning) system, etc.

In an embodiment, the plurality of anode-free battery modules 212 may be connected in parallel to a main traction bus/high voltage DC bus, a plurality of traction modules 216, and a plurality of bi-directional DC-DC converters. In addition, it may have an on-board AC-DC charger, a 12 V battery for powering lights and ignition of the vehicle, an auxiliary DC-DC converter for connecting the 12 V battery to the lights and ignition, contactors for switching various circuits on or off, and a control module for controlling the power supply. An operatively coupled controller may be configured to measure the voltage, current, temperature, SOC and SOH of the each of the individual anode-free cells 100. Each of the anode-free cells 100 may have a voltage sensor 314. Knowing the current passing through the anode-free cell 100 and temperature (such as temperature of various points on the anode-free battery module 212), the SOH, SOC and other parameters for the anode-free cells 100 may be calculated.

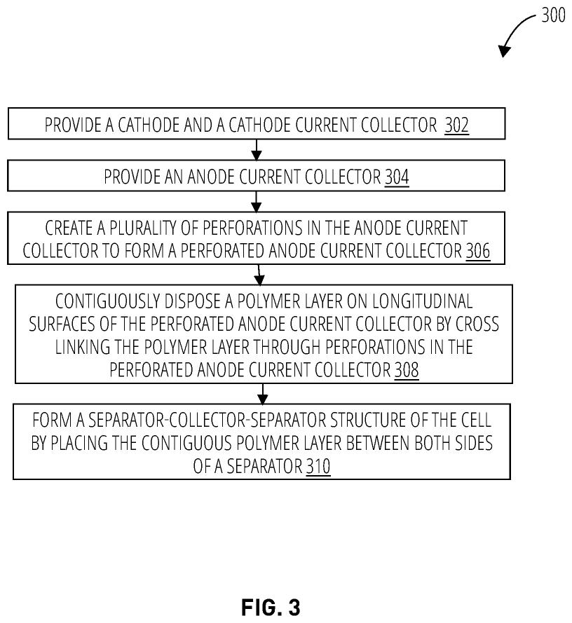

Turning now to FIG. 3, process of manufacturing an anode free cell is disclosed. The process may begin at step 302 wherein a cathode and a cathode current collector may be obtained. In step 304, manufacturing process 300 provides an anode current collector. In step 306, manufacturing process 300 creates a plurality of perforations in the anode current collector to form a perforated anode current collector. In step 308, manufacturing process 300 disposes a contiguous polymer layer on both surfaces of the perforated anode current collector through the perforations in the perforated anode current collector. In step 310, manufacturing process 300 forms a separator-collector-separator structure of the cell by placing the contiguous polymer layer between both sides of a separator and gluing or adhering them together.

The method may also include further includes configuring a size of the plurality of perforations to be between 10 nm to 5 μm.

In another aspect, the method may also include providing a first electric charge to the cell to form a layer of lithium metal having a uniform thickness on both sides of the perforated anode current collector. The method may also include further includes discharging the cell to deplete, at least partially, the layer of lithium metal such that a remaining layer of lithium has another uniform thickness. Moreover, the method may include controlling the charging and discharging of the anode-free cell 100 to be within a selected state of charge (SOC) range corresponding to a defined cycle life and energy density requirement. This may be achieved with a computer or controller such as that of an electric vehicle or other power supply system 200. Other technical features may be readily apparent to one skilled in the art from the following figures, and descriptions.

Having described the anode-free cell 100, power supply system 200 of the anode-free cells 100 and methods of use thereof, reference will now be made to FIG. 4, which shows a block diagram of a computer system 200 that may be employed in accordance with at least some of the illustrative embodiments herein. Although various embodiments may be described herein in terms of this exemplary computer system 400, after reading this description, it may become apparent to a person skilled in the relevant art(s) how to implement the disclosure using other computer systems and/or architectures.

In one example embodiment herein, the computer system 400 forms a part or is independent of computer system 220 of FIG. 2. Moreover, at least some components of the power supply system 200 may form or be included in the computer system 400 of FIG. 4. The computer system 400 may include at least one computer processor 406. Processor 206 and processor 214 of the power supply system 200 may be or form part of computer processor 406 or may be independent of computer processor 406. The computer processor 406 may include, for example, a central processing unit (CPU), a multiple processing unit, an application-specific integrated circuit (“ASIC”), a field programmable gate array (“FPGA”), or the like. The computer processor 406 may be connected to a communication infrastructure (e.g., Network) 402 (e.g., a communications bus, a network). In an illustrative embodiment herein, the computer processor 406 includes a CPU that that controls a process of operating the power supply system 200 controlling charging or discharging of the anode-free cells 100.

The display interface 408 (or other output interface) may forward text, video graphics, and other data about the power supply system 200 from the communication infrastructure (e.g., Network) 402 (or from a frame buffer (not shown)) for display on display unit 414 which may be a display of the electric vehicle. For example, the display interface 408 may include a video card with a graphics processing unit or may provide an operator with an interface for controlling the power supply system 200.

The computer system 400 may also include an input unit 410 that may be used, along with the display unit 414 by an operator of the computer system 400 to send information such as operating voltage ranges to the computer processor 406. The input unit 410 may include a keyboard and/or touchscreen monitor. In one example, the display unit 414, the input unit 410, and the computer processor 406 may collectively form a user interface.

One or more computer-implemented steps of operating the power supply system 200 may be stored on a non-transitory storage device in the form of computer-readable program instructions. To execute a procedure, the computer processor 406 loads the appropriate instructions, as stored on storage device, into memory and then executes the loaded instructions.

The computer system 400 may further comprise a main memory 404, which may be a random-access memory (“RAM”), and also may include a secondary memory 418. The secondary memory 418 may include, for example, a hard disk drive 420 and/or a removable-storage drive 422 (e.g., a floppy disk drive, a magnetic tape drive, an optical disk drive, a flash memory drive, and the like). The removable-storage drive 422 reads from and/or writes to a removable storage unit 426 in a well-known manner. The removable storage unit 426 may be, for example, a floppy disk, a magnetic tape, an optical disk, a flash memory device, and the like, which may be written to and read from by the removable-storage drive 422. The removable storage unit 426 may include a non-transitory computer-readable storage medium storing computer-executable software instructions and/or data.

In further illustrative embodiments, the secondary memory 418 may include other computer-readable media storing computer-executable programs or other instructions to be loaded into the computer system 400. Such devices may include removable storage unit 428 and an interface 424 (e.g., a program cartridge and a cartridge interface); a removable memory chip (e.g., an erasable programmable read-only memory (“EPROM”) or a programmable read-only memory (“PROM”)) and an associated memory socket; and other removable storage units 428 and interfaces 424 that allow software and data to be transferred from the removable storage unit 428 to other parts of the computer system 400.

The computer system 400 may also include a communications interface 412 that enables software and data to be transferred between the computer system 400 and external devices. Such an interface may include a modem, a network interface (e.g., an Ethernet card or an IEEE 402.11 wireless LAN interface), a communications port (e.g., a Universal Serial Bus (“USB”) port or a FireWire® port), a Personal Computer Memory Card International Association (“PCMCIA”) interface, Bluetooth®, and the like. Software and data transferred via the communications interface 412 may be in the form of signals, which may be electronic, electromagnetic, optical or another type of signal that may be capable of being transmitted and/or received by the communications interface 412. Signals may be provided to the communications interface 412 via a communications path 416 (e.g., a channel). The communications path 416 carries signals and may be implemented using wire or cable, fiber optics, a telephone line, a cellular link, a radiofrequency (“RF”) link, or the like. The communications interface 412 may be used to transfer software or data or other information between the computer system 400 and a remote server or cloud-based storage (not shown).

One or more computer programs or computer control logic may be stored in the main memory 404 and/or the secondary memory 418. The computer programs may also be received via the communications interface 412. The computer programs include computer-executable instructions which, when executed by the computer processor 406, cause the computer system 400 to perform the methods as described hereinafter. Accordingly, the computer programs may control the computer system 400 and other components of the power supply system 200.

In another embodiment, software may be stored in a non-transitory computer-readable storage medium and loaded into the main memory 404 and/or the secondary memory 418 using the removable-storage drive 422, hard disk drive 420, and/or the communications interface 412. Control logic (software), when executed by the computer processor 406, causes the computer system 400, and more generally the power supply system 200, to perform some or all of the methods described herein.

Lastly, in another example embodiment hardware components such as ASICs, FPGAs, and the like, may be used to carry out the functionality described herein. Implementation of such a hardware arrangement so as to perform the functions described herein will be apparent to persons skilled in the relevant art(s) in view of this description.

Thus, a cell configuration and method of use are provided in the illustrative embodiments. Where an embodiment or a portion thereof is described with respect to a type of device, the method, power supply system, or a portion thereof, are adapted or configured for use with a suitable and comparable manifestation of that type of device.

The present invention may be a device, a method, and/or a computer program product for controlling or manufacturing the cell at any possible technical detail level of integration. The computer program product may include a computer readable storage medium (or media) having computer readable program instructions thereon for causing a processor to carry out aspects of the present invention.

The flowchart and block diagrams in the Figures illustrate the architecture, functionality, and operation of possible implementations of anode-free cells, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. An anode-free cell comprising:
a cathode; and
a separator-collector-separator structure comprising:
a perforated anode current collector; and
a polymer layer contiguously disposed on both longitudinal surfaces (X-Z plane) of the perforated anode current collector through perforations in the perforated anode current collector, the polymer layer being a binder;
wherein the separator-collector-separator structure is configured as one unit.

2. The anode-free cell of claim 1, wherein the separator-collector-separator structure further comprises:
a base separator film separating the separator-collector-separator structure from the cathode and;
a ceramic layer disposed between the base separator film and the polymer layer.

3. The anode-free cell of claim 1, wherein the polymer layer of the separator-collector-separator structure comprises a material that is compliant to applied forces by stretching elastically to accommodate lithium plating while providing an inwardly directed pressure in the cell that constrains said lithium plating to a uniform space about the perforated anode current collector and/or suppresses lithium dendrite formation.

4. The anode-free cell of claim 1, wherein the perforations are distributed uniformly across the perforated anode current collector.

5. The anode-free cell of claim 1, wherein the perforated anode current collector comprises a material selected from the list consisting of: a Cu (copper) foil, a Ni (nickel) foil, a Ti (titanium) foil, a SS (stainless steel) foil, an Al (aluminum) foil, an alloy foil, and a metalized polymer film metallized with one or more of the foils.

6. The anode-free cell of claim 5, wherein the perforated anode current collector further comprises any of the foils which is further plated with a different metal.

7. The anode-free cell of claim 6, wherein said different metal comprises a thickness of 10 nm to 5 μm.

8. The anode-free cell of claim 5, wherein said metalized polymer film comprises a material selected from the list consisting of PET (polyethylene terephthalate), PE (polyethylene), PP (polypropylene), PVC (polyvinyl chloride) and PI (polyimide).

9. The anode-free cell of claim 8, wherein the foils of said metallized polymer film comprise one or more metal layers.

10. The anode-free cell of claim 1, wherein the perforated anode current collector has a pore size that ranges from 10 nm to 5 μm.

11. The anode-free cell of claim 1, wherein the perforated anode current collector has a thickness of 3 μm to 50 μm.

12. The anode-free cell of claim 1, wherein the polymer layer is an elastomer.

13. The anode-free cell of claim 1, wherein the polymer layer material comprises PVDF (polyvinylidene fluoride), PTFE (Polytetrafluoroethylene) or PMMA (polymethyl methacrylate).

14. A battery comprising a plurality of anode-free cells, wherein each anode-free cell comprises:
a cathode; and
a separator-collector-separator structure comprising:
a perforated anode current collector; and
a polymer layer contiguously disposed on longitudinal surfaces of the perforated anode current collector through perforations in the perforated anode current collector;
wherein the separator-collector-separator structure is configured as one unit and the polymer layer is a binder.

15. The battery of claim 14, wherein the plurality of anode-free cells have a stacked configuration.

16. The battery of claim 14, wherein the battery is operable by a battery management system to have one or more charge/discharge rates selected to optimize anode-free cell life.

17. A method comprising:
manufacturing an anode free cell by:
providing a cathode and a cathode current collector;
providing an anode current collector;
creating a plurality of perforations in the anode current collector to form a perforated anode current collector;
contiguously disposing a polymer layer on longitudinal surfaces of the perforated anode current collector through perforations in the perforated anode current collector; and
forming a separator-collector-separator structure of the cell by placing the contiguously disposed polymer layer having the perforated anode current collector between both sides of a separator,
wherein the separator-collector-separator structure provides an inwardly directed pressure that constrains lithium plating to a uniform space about the perforated anode current collector and/or suppresses lithium dendrite formation.

18. The method of claim 17, further comprising:
configuring a size of the plurality of perforations to be between 10 nm to 5 μm.

19. The method of claim 17, wherein the contiguously disposed polymer layer is glued or adhered to said both sides of the separator.

20. The method of claim 17, further comprising:
providing an electric charge to the cell to form a layer of lithium metal having a uniform thickness on both sides of the perforated anode current collector.

21. The method of claim 20, further comprising:
discharging the cell to at least partially deplete the layer of lithium metal such that a remaining layer of lithium has another uniform thickness.
